(19) United States
(12) Patent Application Publication
(10) Pub. No.: US 2015/0221013 A1
(43) Pub. Date: Aug. 6, 2015

(54) PORTABLE WIRELESS DEVICES ASSOCIATED WITH ASSETS IN A FACILITY WIRELESSLY PROVIDING DATA DIRECTLY TO PORTABLE WIRELESS DEVICES CARRIED BY USERS IN THE FACILITY

(71) Applicants: Derek Rinicella, Streetsboro, OH (US); Dean Rinicella, Aurora, OH (US)

(72) Inventors: Derek Rinicella, Streetsboro, OH (US); Dean Rinicella, Aurora, OH (US)

(21) Appl. No.: 14/613,124

(22) Filed: Feb. 3, 2015

Related U.S. Application Data
(60) Provisional application No. 61/934,930, filed on Feb. 3, 2014.

(51) Int. Cl. G06Q 30/06; H04W 4/00

(52) U.S. Cl. CPC G06Q 30/0623; H04W 4/008

(57) ABSTRACT

Self-contained units provided associable with assets in a facility to provide information wirelessly portable handheld wireless devices carried by users to provide information about the assets. Units can also provide information to users located next the unit associated with assets and provide a user interface for user to obtain information and interact with the unit. Asset information can include: asset location, asset information, processing steps for handling assets, coupons, recipes, and remote information access via website URLs. Units are capable of autonomous operation and physical association with product or assets located throughout a store or warehouse. A short-range wireless module supports interaction with portable handheld wireless devices (e.g., smartphones, tablets, and/or data-enabled glasses) carried by customers and employees. A unit can utilize the short-range wireless module of various standards to broadcast information to portable handheld devices carried by users near the unit to provide asset information.

### CROSS REFERENCE TO RELATED APPLICATIONS

This patent application claims the benefit under 35 U.S.C.§119(e) of U.S. Provisional Patent Application Ser. No. 61/934,930 filed on Feb. 3, 2014, entitled “PORTABLE WIRELESS DEVICES ASSOCIATED WITH ASSETS IN A FACILITY WIRELESSLY PROVIDING DATA DIRECTLY TO PORTABLE WIRELESS DEVICES CARRIED BY USERS IN THE FACILITY,” which is hereby incorporated by reference in its entirety.

### FIELD OF THE INVENTION

The present invention is related to mobile devices and their use in the exchange or access of information. More particularly, the present invention is related to a self-contained, portable device that can be physically placed in association with products and/or assets in a facility for the purpose of providing information about the products and/or assets to portable mobile devices carried by users in the facility.

### BACKGROUND

Product, inventory, and other assets are placed, stored, and held in, or moved about within large facilities such as stores and warehouses. Limited information is generally available in association with products. For example, information devices and coupon dispensers are sometimes placed next to products placed on store shelves so that customers can obtain information or discounts for the associated product. Typically, electronic information devices are not wireless, nor can they synchronize and communicate information with portable hand held devices carried by users such as customers or enterprise employees. Portable devices are not typically provided in association with inventory stored in warehouses or storage rooms. Sometimes the lack of a strong cellular or Wi-Fi network signal in retail stores or warehouses prohibit data exchanges that would normally occur in the real world (office and home) from happening in more limiting environments. What is needed is a portable, wireless device that can more effectively integrate with hand held devices and provide information about products or assets being sold or stored.

### SUMMARY

It is a feature of the present invention to provide a self-contained information device (e.g., a “unit”) adapted for autonomous operation and physical association with products or assets located throughout a store or warehouse. The unit can include a scanner, short-range wireless module for interaction with portable wireless devices, such as smartphones, tablet, and data-enabled glasses used by customers and employees, touch sensitive screen for direct interaction by customers and employees, product information modules for displaying and/or announcing information about associated products or assets, and wireless broadcast capabilities for transmitting additional information to portable wireless devices (e.g., coupons, recipes, website URLs, location information, etc.). Advertising video rendered on the screen can be in the form of a media loop, periodically repeating information about an associated product. Instructional video can also be rendered on the screen in the form of tutorials or steps for handling assets with which the device is associated with during shipping or storage.

It is another feature of the present invention that units provided as part of a system can wirelessly transfer coupons and information automatically onto portable handheld wireless devices carried by user's via short-range wireless communications that can be achieved with portable handheld wireless devices via wireless field communication (WFC) modules. The WFC can be provided in the form of Bluetooth technology, including low energy Bluetooth technology, Wi-Fi direct, and NFC communications, depending on the range required for a given application. An application on a portable handheld wireless devices carried by user's throughout a facility can be separately set up (e.g., user profiles) to accept or deny information from the self-contained information device (Unit) associated with product in a store and inventory in a warehouse.

It is yet another feature of the present invention that the system can also operate as a positioning system within a store environment for portable handheld devices roaming about the store environment. The system units can operate like a beacon where its location information can be utilizable by portable handheld wireless devices carried by user throughout the facility to navigate the facility using a map that can be rendered on a display screen associated with the portable handheld wireless devices. This feature would be useful in large shopping venues, such as malls, amusement parks, and sports venues as well as large warehouses.

A field service capability can be provided in association with the self-contained information device. Units deployed in the field sometimes require that local service representatives visit the store to service and update the units. The use of representatives adds to the cost of unit use/ownership. It would be desirable for store employees/management to provide maintenance and data upgrade tasks locally. Store employees and management can utilize a handheld tablet or smartphone to download data upgrades, then connect to each unit and upgrade information associated with an existing product or a new product the unit will become associated with.

It is another feature of the invention that the units can also be utilized as an asset-tracking beacon. A unit can be located as a beacon with a shipment (e.g., goods on a pallet or in a cargo box) and a portable wireless device (e.g., smartphone, tablet or data-enabled glasses) can be used to find the location of a particular shipment based on its associated with a wireless device communicating wireless using Bluetooth LE (low energy) or WiFi direct. A handheld device can hone in on the shipment based on signal strength (e.g., a signal strength meter displayed on a display or a sound pattern that intensifies and become rapid).

The device can also be used to track equipment, such as hospital equipment, being used throughout a hospital facility. The system can track to location of its use and other users can track the location of the system based on its signal.

Patients and pets can also be tracked using the wireless module associated with this system. For example, a patient wearing/associated with the device can roam about a controlled environment, but notifications can be sent or alarms triggered if the patients roams outside of a controlled environment/zone. If the patient should fully escape the controlled environment, the wireless module acts as a beacon to enable staff with portable devices to track the patient's locations or direction.

### DRAWINGS

FIG. 1 illustrates a high-level block diagram of the system unit, in accordance with the present invention;

FIG. 2 is a photograph of a prototype system, in accordance with features of the present invention;

FIG. 3 illustrates a system interaction diagram, in accordance with features of the present invention;

FIG. 4 illustrates a system interaction diagram, in accordance with features of the present invention; and

FIG. 5 illustrates a system interaction diagram, in accordance with features of the present invention.

### DETAILED DESCRIPTION OF THE INVENTION

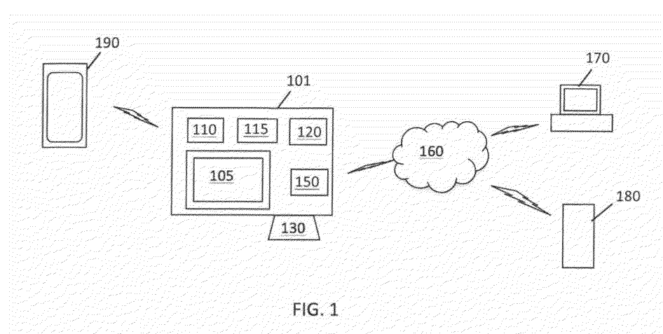

Referring to FIG. 1, a unit 101 making up part of a an asset information system system can be provided similar in form to a portable hand held device, e.g., tablet or smartphone, and can be Flash-based, include a touch-sensitive display screen 105, feature programming module 110, memory 115, and a short-range wireless module 120. A general purpose of the system can be for its use as an “at shelf,” point of sale information system. It can be used as a video delivery system, a question and answer product selector system, a listening center (headphones, soundbars, docking stations, etc.), and can further include an optional bar code scanning system 130 or any combination of all the previous mentioned functions.

An android backer stored as programming in feature programming module 110 can be included in the system to add the features of true tablet and smartphone functions such as “swype” touch screen control (where a user swipes their finger across the screen to get scrolling type movement), loading of apps onto the unit which gives stores and their customers more control and features compared to a normal flash based system. The short-range wireless module 120 can enable short-range wireless communications features. The unit can also include WiFi or cellular communications module 150 enabling the unit to also connect to a network 160 whether that be a cell network or retailer network. By connecting to a network 160, the unit 101 can be checked remotely by a service client 170 to ensure it is working and playing the latest content, metrics can be sent from the unit 101 to a remote server 180 and the unit can be updated with content remotely from the server 180.

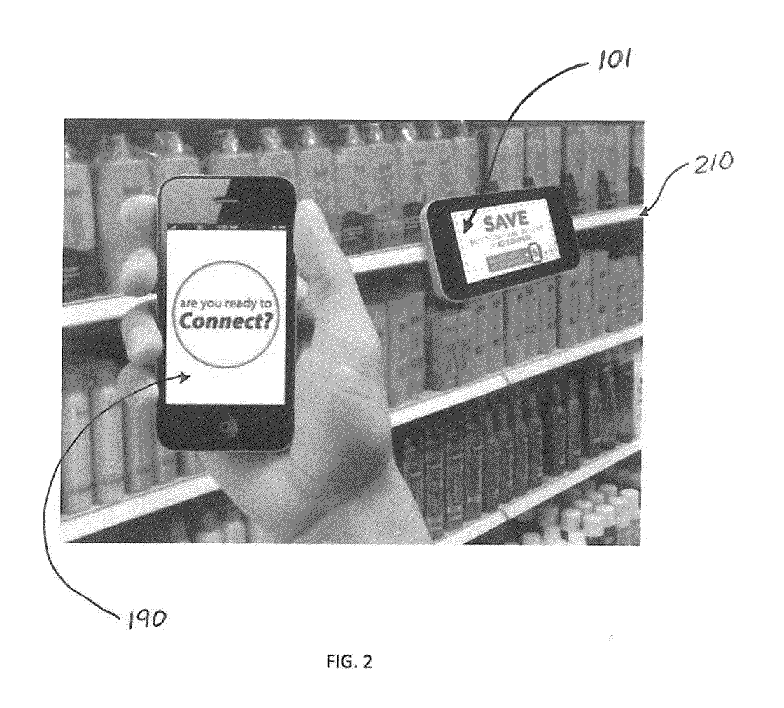

Referring to FIG. 2, a photograph is shown of a prototype system where a unit 101 in portable tablet form is attached to a shelf 210. The unit is shown with a display screen 105 capable of displaying information to user's standing next to the unit 101. Also shown proximate to the unit 101 is a portable hand held device 190 that can wirelessly connect to and interact with the unit 110. Close proximity wireless features enable unique features for the current invention and can be carried out by the short-range wireless module 120. This short-range wireless feature can enable a wireless connection between the unit 110 and a user's (customer or employee) portable handheld wireless device 190 (smartphone, tablet, and/or data-enabled glasses). The user portable handheld wireless devices 190 do not need to have a special app downloaded to communicate with the unit 101 and do not need to be connected to any type of network. Communication can occur directly with the unit 101. This feature allows brands or retailers to give the consumer a “takeaway” that is dropped onto their device via their phones browser once the device is connected to the short-range wireless signal that the device can broadcast. Short-range wireless technology such as Bluetooth and RFID can support short-range communications. In particular, Bluetooth LE (low energy) can limit the distance wherein a user carried portable handheld wireless device 190 can communicate with a portable device 101, in accordance with teachings of the present invention.

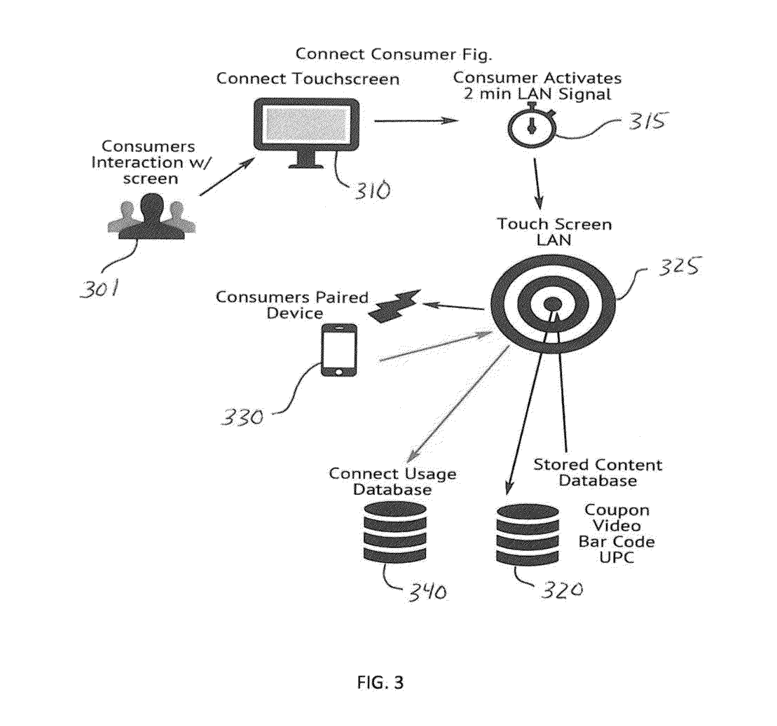

Referring to FIG. 3, a block diagram of system interaction is illustrated, in accordance with features of the present invention. Consumers 301 can begin interaction with a unit 310 on its touchscreen. Access to the unit can provide information already stored therein in association with products that it is physically associated with in a facility. The system can also initiate communications with the store network at shown by timer 315. Once connected to the store network 325, the consumer 301 can access addition information associated with the product or store content database 320. Access to data can also be via a portable hand held device 330 used by the consumer to connect (pair where Bluetooth is used) with the Unit 301 and/or the store network. Unit interaction and data access from all units can be tracked via a usage database 340.

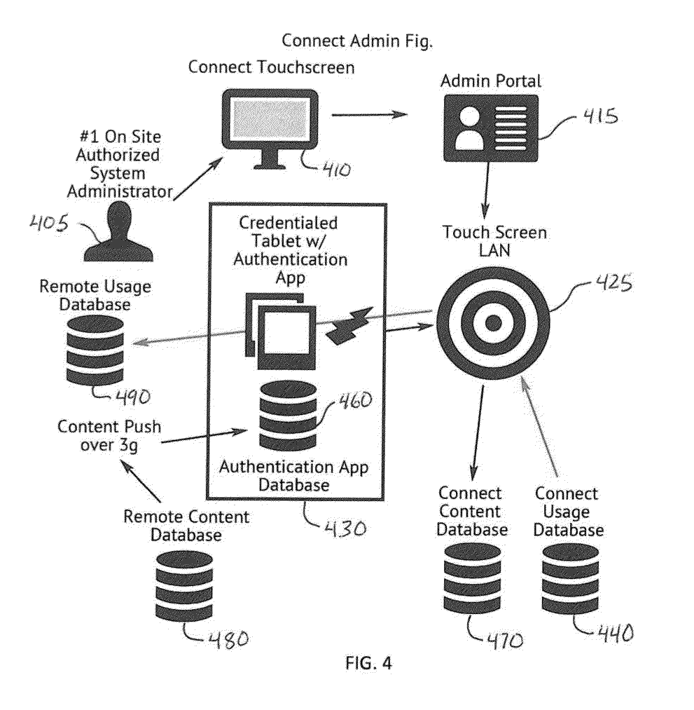

Referring to FIG. 4, a system interaction diagram is illustrated, in accordance with features of the present invention. A unit 410 associated with an asset in a facility is shown interacting with an on-site authorized administrator 405. The unit 410 can access a administrative portal 415 via the facility local area network (LAN) 425wherefrom the authorized administrator 405 can update/program the unit 410, and also access usage content database 440 and content database 470. Data from the content database can be used to update the unit 410. Usage data can provide the administrator with statistics regarding content access via the unit 410 and customer interaction with the unit 410. Access by an administrator 405 can also be provided over a portable hand held device 430.

The administer and device can be authenticated via an authentication application and database 460 before service/changes can be performed in the system. The administrative portal 415 or the portable hand held device 430 can also provide the administrator 405 with access to remote content database information from a remote content database 480. Data from the remote content database 480 can enable a multi-location enterprise to provide updates to facilities via data networks. Update can be provided to the local content database 470.

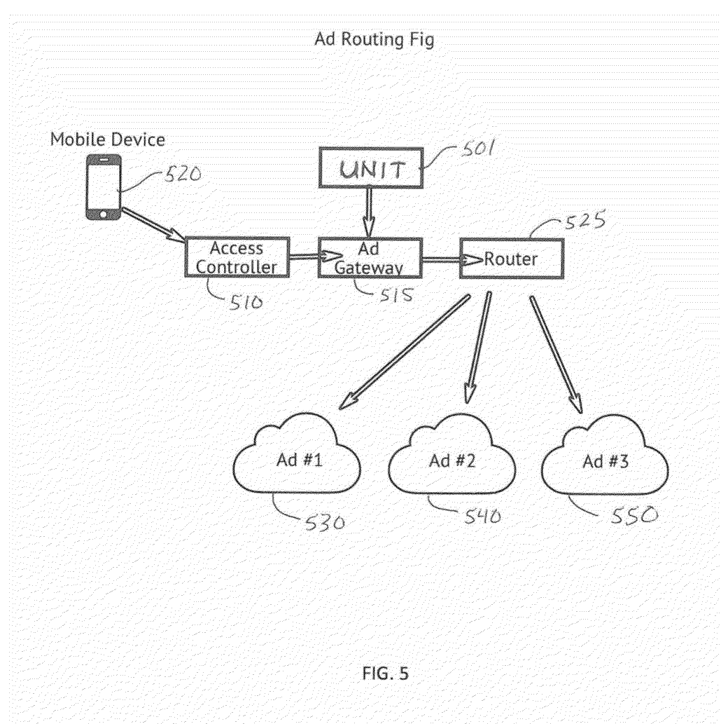

FIG. 5 illustrates, a portable hand held device 520 accessing an access controller 510 associated with a facilities network of units 101. Access controller 510 can enable a portable hand held device 520 to retrieve or be pushed advertising data 530, 540, 550, via a router 525 from an advertising gateway 515. The advertising data can be pushed to a portable hand held device 520 as it come into dose proximity to the unit 501, or at the request of the portable hand held device 520 user at the unit 501 or via the portable hand held device 520 when connected to the unit 501.

Based on customer requests (the brand or retailer), a call to action to initiate the short-range wireless features can be on the first screen on the system or on the last screen. Once the user presses the WFC (wireless field communications) button on their portable handheld wireless device, they can be instructed to use their portable handheld wireless device to find the data providing device's Wi-Fi signal (e.g., find “INFINITY”). Many users can have their smartphones to self-discover available Wi-Fi networks or Bluetooth device so the process of connecting can be more simple than noted here, but a proven way to connect would be to go to SETTINGS on your device, select WFC, search for WFC signals, find INFINITY, and press on INFINITY to connect (no password will be needed to connect to the Wi-Fi signal). Once connected, the consumer will be instructed to open their portable handheld wireless device's browser (Safari for iPhones, Google for most Android). When that is done the Connect unit will display on the phones web browser the “takeaway”. This “takeaway” can be a coupon with Bar Code that can be scanned by the retailer to be redeemed at checkout, but can also be a variety of other things—i.e.—weblink to direct consumers to the retailers or brands website to redeem a rebate, get more consumer personal data, etc.—recipes based on what item is being purchased—shopping lists for recipe ideas—web links to instruction or installation videos—suggestion items to compliment the item being purchased (food to go with wine or beer selected, other items needed to complete a certain project, etc.).

Once the consumer opens the browser on their portable handheld wireless device, they can also take a screen shot of the web page to save what they see on their device (e.g., a coupon).

The portable unit will show step by step instruction with “are you ready to continue prompts” with multiple screen levels to guide the consumer through the process of getting the takeaway.

Page #1=Do you wish to receive the takeaway offer?

Page #2=Find the device's wireless signal using your portable handheld wireless device: open SETTINGS—search for short-range wireless signals (ssid)—Select applicable signal.

Page #3=What type of portable handheld wireless device are you using: IPHONE—IPAD—GOOGLE GLASSES—ANDROID—WINDOWS?

Page #4=Instructions based on portable handheld wireless device choice on what browser to open and what to do if takeaway is not seen when browser is first opened.

Page #5=Instructions on how to take a screen shot to save the takeaway based on what portable handheld wireless device a user has.

### SERVICES

Service representatives (rep) can utilize a Service App on their portable handheld wireless device to upgrade and maintain field units. The service App can be opened when the Rep is in close proximity (e.g., directly in front) of the portable device unit in-store to start the authorized service communication between the unit and the rep's portable handheld wireless device.

UPDATING CONTENT: The rep can receive the updated content via an e-mail link that they can use to load the content onto their portable handheld wireless device, which will be stored in a folder on the Service App. When the rep's portable handheld wireless device is in front of the unit it can open the Service App, e.g., the Infinity Connect unit an recognize the Service App and a screen will appear asking the rep what they want to do—Upload Content or Pull Metrics and Measures. The rep can select Upload Content and the unit can then automatically pull and update the content as needed from the rep's portable handheld wireless device.

METRICS: Similar to the above, if the rep chooses METRICS the portable unit can push the latest data from the unit to the Rep's portable handheld wireless device. Once the rep has a good cellular or WiFi signal, the data can be sent to a remote server (e.g., corporate, contractor, or 3^{rd} party data Collection agency). The data can then be processed into charts and graphs to be sent to any interested party that may be paying for the data collection.

### SERVICE OVERVIEW

The individual technologies that make up the disclosed system can include:

Portable Device Units
Programmable with service features provided from carried user portable handheld wireless devices
User interface (e.g., buttons, touch screen interface, or both)

RF Technology (e.g., Bluetooth, NFC, WiFi, Cellular)

Network Access
In-store network and/or cellular data plan

Service Modules
Request help in an aisle
Connect with iFinder Product Locator
Pairing Units with user portable handheld wireless devices
Range variable/controllable with mixed RF module usage
Connect portable units associated with product to user portable handheld wireless device
Take-away—coupons, product info, instructions (how-to's, recipes) from portable device units to user portable handheld wireless devices
Service Updates—Update content on units associated with product/inventory/assets using reps portable handheld wireless device
Pull metrics/push maintenance or content changes from/to remote server to units or from portable handheld wireless devices in association with servicing a unit
Receive “metrics” on usage and battery levels for in-store displays
Request help in an aisle

Print module
Print to an “in-store printer”-coupons or instruction information

Barcode Scanner
Product information and videos
Coupons
Instruction/Directions

An Interactive display on a unit 101 can include a microprocessor based media computer that allows interaction with a shopper. The system can be either AC powered or battery powered. The display can be placed at a convenient location on a shelf, a counter top, or any location that would allow a shopper to make selections for product information and obtain coupons, recipes, or other desired data through a wireless connection to the shopper's portable wireless device (e.g., smartphone, tablet device, and/or data-enabled glasses).

How the system works for a shopper: The shopper can make selections on the display 105 by either touching the front-sided buttons on the side of the display or by touching the touchscreen (if so equipped). When the desired information is displayed, the customer can request a copy of the information through a wireless frequency connection to their portable handheld wireless device (e.g., smartphone, tablet, and/or data-enabled glasses). The shopper could use their portable handheld wireless device to look for the interactive display, accept a connection to the interactive display, then save the displayed information to their portable handheld wireless device. The system can terminate the connection shortly after the information is transferred. The range of the wireless connection can be limited in distance so as not to interfere with other wireless networks in the area. Transfer of data can be from the interactive display to the intended shopper based on location and communication range, or range of the intended shopper to the unit.

Application programming and metrics: The display can contain applications (Apps) specific for the functions required to display content, information gathering, information usage, and software updatability. Advanced controls will be protected by username and password to allow updates and metrics to be obtained and/or programmed by specific approved “users” or “representatives”. Data can be communicated by a wired USB port or a wireless communication port.

Locating assets: When associated with assets in a warehouse or other facilities, a combination of short range and longer range wireless signals can be used to hone in on units. For example, the portable system representing the unit can be attached to a pallet of product in a warehouse. A WiFi connection can be used to hone in on the asset's general location using a portable handheld wireless device carried by a user. Once in the general location, the short-range wireless module (e.g., Bluetooth LE) can be used as a beacon fro the portable handheld wireless device to hone in on the portable system and the shipment. If the shipment requires special handling, a tutorial can be retrieved from the unit or can be viewed directly on the display associated with the portable system, or can be displayed on the user's portable handheld wireless device. The tutorial can tell a user how to handle, move, deploy, or use the shipped item (e.g., it may be equipment or hardware).

The device could also be attached in association with a live asset (e.g., person, pet) to find the live asset via wireless beaconing technology described above.

System Technology: The displays can have a wireless module internal to the unit, which can be 802.11b/g/n (Wi-Fi) compliant as well as 802.15.1 (Bluetooth) and Bluetooth LE compliant. The wireless module can allow communication between two devices that are “paired” at time of use. Specific applications can be written to control information flow between the display and the “paired” device.

1. A system including units provided in the form of a portable wireless devices associable with assets in a facility to provide information directly to users located next to the unit and also wirelessly communicative with portable handheld wireless devices carried by users to provide information about the assets, each unit comprising:
a housing for a self-contained information device adapted for autonomous operation and physical association with the assets located throughout the facility;
a short-range wireless module for wireless communication with the portable handheld wireless devices;
a touch sensitive screen for direct interaction with the users located next to the unit, said touch sensitive screen displaying information and receiving physical input; and
an asset information module for displaying and/or announcing information about an asset associated with a particular unit.

2. The system of claim 1, wherein the short-range wireless module broadcasts information to the portable handheld wireless devices carried by users in the facility to provide asset information including at least one of: asset location, asset information, processing steps for handling assets, coupons, recipes, and remote information access via website URLs.

3. The portable wireless device associated with assets in a building of claim 1, further comprising at least one of WiFi or cellular data communications module to enable access to remote servers and data for use/display at the portable, wireless system when associated with products or assets.

4. A retail product information system, comprising:
units provided in the form of a portable wireless devices attached to store shelving associable with product offered for sale in the store, said unit providing information directly to users located next to the unit or wirelessly communicating with the unit via a portable handheld wireless devices carried by users to access information about the product, each unit further comprising:
a housing for enabling the unit to be a self-contained information device adapted for autonomous operation and physical association with a specific product located within the store;
a short-range wireless module supporting wireless communication with at least one of the portable handheld wireless devices and a local area network associated with the store;
a touch sensitive screen support direct interaction with customers becoming located next to a particular unit, said touch sensitive screen displaying information to and receiving physical input from the customers becoming located next to a particular unit; and
an asset information module for displaying and/or announcing information about a product associated with the specific product within the store.

5. The system of claim 3, wherein the short-range wireless module broadcasts information to the portable handheld wireless devices carried by customers in the facility to provide product information including at least one of: product location, product information, coupons, recipes, and remote information access via website URLs.

6. A method for providing asset information to occupants in a facility, comprising:
providing units in the form of a portable wireless devices in association with assets deployed throughout a facility;
enabling the occupants of the facility to interact with the units to access information about a particular asset when located next to a particular unit via a display screen integrated with the unit; and
enabling portable hand held devices carried by users to wireless access and communicate with a selected unit and access information about specific product the selected unit is associated with

7. The method of claim 6, wherein the units each include:
a housing for a self-contained information device adapted for autonomous operation and physical association with the assets located throughout the facility;
a short-range wireless module for wireless communication with the portable handheld wireless devices;
a touch sensitive screen for direct interaction with the users located next to the unit, said touch sensitive screen displaying information and receiving physical input; and
an asset information module for displaying and/or announcing information about an asset associated with a particular unit.

8. The method of claim 6, wherein the asset information included at least one of: asset location, asset information, processing steps for handling assets, coupons, recipes, and remote information access via website URLs.
